(19) United States
(12) Patent Application Publication
(10) Pub. No.: US 2013/0038216 A1
(43) Pub. Date: Feb. 14, 2013

(54) REMOTE CONTROLLED ELECTRONIC BALLAST WITH DIGITAL DISPLAY

(71) Applicant: Alvin Hao, Cerritos, CA (US)

(72) Inventor: Alvin Hao, Cerritos, CA (US)

(21) Appl. No.: 13/354,239

(22) Filed: Jan. 19, 2012

(51) Int. Cl. H05B 37/02; H05B 37/03

(52) U.S. Cl. 315/132; 315/292

(57) ABSTRACT

The present invention is a remote controlled electronic ballast, which preferably includes: a ballast, counter, scheduling timer, remote control, digital display screen, ignition control, and diagnostic circuitry. The counter preferably tracks the total hours in which the ballast has operated. This count may be displayed, if requested on the digital display screen. The scheduling timer preferably triggers the ballast to ignite and/or drive the lamp at various time intervals. The remote control preferably allows the user to wirelessly: (1) set the wattage output; (2) control the timer settings; (3) display the count; and/or (4) turn the lamp on or off. The display preferably provides visual information of the ballast's setting. The ignition control preferably allows the user to start up multiple lamps in a series to prevent the breaker from being tripped. The diagnostic and sensory circuitry preferably performs a pre-ignition check for fault conditions.

### FIELD OF THE INVENTION

The present invention relates to wirelessly controlled lighting ballasts. In particular, the present invention is a ballast device with a digital display that is capable of being remotely activated and configured for wattage control, timer settings specific to horticulture, counter display, and activation.

### BACKGROUND OF THE INVENTION

Lighting assemblies have been used for over a century to provide light where desired. Conventional lighting assemblies typically include a one or more lamps or light sources mounted in a lighting fixture; wherein the ends the lamps are electrically coupled to one or more electronic ballast assemblies. Current from the ballast is generally directed to a first end of each lamp and subsequently returned from a second end of the lamp.

As fluorescent lighting systems became popular, engineers and designers have strived to conserve and manage electrical power to save both on costs and on the environmental impact of the systems through increased efficiency. As a result of trying to increase efficiency, wireless control systems for lighting assemblies were created.

Regarding those references that disclose wireless ballast systems, U.S. Published Patent Application No. 2003/0209999, issued to Shu Yuen Ron Hui et al., for example, discloses a lighting system for a dimmable electronic ballast with a remote control. The system includes a transmitter module for transmitting dimming data to the ballast, and a receiver module for receiving the dimming data and outputting a dimming signal. The lighting system of the transmitter module may be activated with an ON/OFF operation and may include address data identifying the ballast to be controlled.

Additionally, U.S. Published Patent Application No. 2011/0184577, issued to Lasclo Sandor Ilyes discloses a ballast control unit for controlling lamps of a dimmable ballast. The dimmable ballast powers the light sources via the light output(s), through a ballast control unit, which includes a wireless interface to send and receive messages and a control module to control the dimmable ballasts and light outputs.

Currently, however, none of the ballasts with a remote control also feature a digital display or the ability to adjust: wattage settings; custom timing schedules specific to horticulture; and/or activation times. The wattage settings provide adjustments to the wattage output of the ballast, and the activation times and timing schedules provide custom grow and bloom schedules used for horticulture. Further, currently available ballasts lack a display screen to display relevant information about the ballast and a counter to track the amount of usage of the ballast since its initial operation.

Therefore, what is needed is a ballast device that can be remotely activated, controlled, configured, set, and stopped, which allows a user to input and access various information such as wattage settings, timing schedules, and activation times. The ballast should preferably include a counter that tracks the cumulative usage of the ballast.

### SUMMARY OF THE INVENTION

To minimize the limitations in the prior art, and to minimize other limitations that will become apparent upon reading and understanding the present specification, the present invention discloses a new and useful electronic ballast device, which is controlled via remote control.

One embodiment of the present invention is a remote controlled ballast, comprising: a ballast; and a remote control. The ballast is connected to one lamp, and the ballast includes a wireless interface and a counter. The wireless interface receives one or more signals sent from the remote control, and the remote control allows a user to wirelessly activate the ballast. The remote control allows the user to wirelessly configure the ballast; and the counter tracks a cumulative operation time of the ballast. Preferably, the ballast includes a central processing unit; wherein the central processing unit includes one or more scheduling functions. The various scheduling functions specific to horticulture preferably includes: −12/12; −18/6; −19/5; −20/4; −21/3; −22/2; and −23/1; wherein −12/12 activates the ballast for 12 hours on and deactivates the ballast for 12 hours off; −18/6 activates the ballast for 18 hours on and deactivates the ballast for 6 hours off; −19/5 activates the ballast for 19 hours on and deactivates the ballast for 5 hours off; −20/4 activates the ballast for 20 hours on and deactivates the ballast for 4 hours off; −21/3 activates the ballast for 21 hours on and deactivates the ballast for 3 hours off; −22/2 activates the ballast for 22 hours on and deactivates the ballast for 2 hours off; and −23/1 activates the ballast for 23 hours on and deactivates the ballast for 1 hour off. The one or more scheduling functions are preferably selected by the user. The one or more scheduling functions preferably triggers the ballast to ignite and drive the one or more lamps at one or more time intervals. Preferably, the ballast includes one or more diagnostic circuits. The one or more diagnostic circuits typically performs a pre-ignition test, and the pre-ignition test detects one or more fault conditions of the ballast and of the one or more lamps. The one or more fault conditions should be an end-of-lamp life fault. The one or more fault conditions should be a temperature failure fault. The one or more fault conditions may be selected from the group consisting of: an open circuit; a short circuit; and an ignition failure fault. The ballast preferably includes one or more display screens. The one or more display screens should display the cumulative operation time. Preferably, the remote control includes: one or more remote control display screens; wherein the one or more remote control screens should display one or more ballast information. The one or more ballast information is preferably selected from the group consisting of: a wattage setting; a program start time; and a program operating time. The wattage setting should be a desired wattage configuration of the ballast. The program start time should be an initial start time of the one or more scheduling functions; and the program operating time should be a total scheduled operation time of the one or more scheduling functions, in which the ballast is typically scheduled to operate. Preferably, the remote control includes an ignition control; wherein the ignition control allows the user to ignite at least two lamps sequentially when the at least two lamps are connected to at least two ballasts.

Another embodiment of the present invention is a remote controlled ballast, comprising: a ballast; and a remote control. The ballast is connected to one or more lamps; wherein the ballast includes a wireless interface and one or more display screens. The wireless interface receives one or more signals sent from the remote control. The remote control allows a user to wirelessly activate and configure the ballast; and the remote control allows the user to wirelessly configure the ballast. Preferably, the ballast includes a counter; wherein the counter tracks a cumulative operation time of the ballast. Preferably, the one or more display screens displays the cumulative operation time. Preferably, the ballast includes a central processing unit; wherein the central processing unit includes one or more scheduling functions; and the one or more scheduling functions are preferably selected by the user. The one or more scheduling functions preferably triggers the ballast to ignite and drive the one or more lamps at one or more time intervals. Generally, the ballast includes one or more diagnostic circuits. The one or more diagnostic circuits should perform a pre-ignition test; wherein the pre-ignition test should detect one or more fault conditions of the ballast and of the one or more lamps. Preferably, the remote control includes one or more remote control screens; wherein the one or more remote control screens should display one or more ballast information. The one or more ballast information is typically selected from the group consisting of: a wattage setting; a program start time; and a program operating time. The wattage setting is preferably a desired wattage configuration of the ballast. The program start time is preferably an initial start time of the one or more scheduling functions, and the program operating time is preferably a total scheduled operation time of the one or more scheduling functions, in which the ballast is scheduled to operate. Preferably, the remote control includes an ignition control, and the ignition control allows the user to ignite at least two lamps sequentially when the at least two lamps are connected to at least two ballasts. Preferably, the one or more fault conditions is selected from the group consisting of: an open circuit fault; a short circuit fault; an ignition failure fault; a temperature failure; and an end-of-lamp life.

Another embodiment of the present invention is a remote controlled ballast, comprising: a ballast; and a remote control. The ballast is connected to one or more lamps. The ballast includes a wireless interface; a counter; a central processing unit; one or more diagnostic circuits; and one or more display screens. The wireless interface receives one or more signals sent from the remote control, and the remote control allows a user to wirelessly activate the ballast. The remote control allows the user to wirelessly configure the ballast, and the counter tracks a cumulative operation time of the ballast. The central processing unit includes one or more scheduling functions, and the one or more scheduling functions are selected by the user. The one or more scheduling functions trigger the ballast to ignite and drive the one or more lamps at one or more time intervals. The ballast includes one or more diagnostic circuits, and the one or more diagnostic circuits performs a pre-ignition test. The pre-ignition test detects one or more fault conditions of the ballast and one or more lamps. The one or more fault conditions is selected from the group consisting of: an end-of-lamp life fault; a temperature failure fault; an open circuit fault; a short circuit fault; and an ignition failure fault. The one or more display screens displays the cumulative operation time, and the one or more display screens displays the one or more fault conditions of the ballast and the one or more lamps. Preferably, the remote control includes: one or more remote control display screens; and an ignition control. The one or more remote control screens typically display one or more ballast information, and the one or more ballast information is typically selected from the group consisting of: a wattage setting; a program start time; and a program operating time. The wattage setting should be a desired wattage configuration of the ballast. The program start time should be an initial start time of the one or more scheduling functions. The program operating time should be a total scheduled operation time of the one or more scheduling functions, in which the ballast is typically scheduled to operate, and the ignition control should allow the user to ignite at least two lamps sequentially when the at least two lamps are connected to one or more ballasts.

It is an object of the present invention to provide a ballast device that can be remotely activated and configured.

It is an object of the present invention to provide a ballast with a fully custom pre-programmed grow/bloom light schedule, such that an external timer is unnecessary. The present invention allows various timer options, which can be configured as: −12/12; −18/6; −19/5; −20/4; −21/3; −22/2; and −23/1; wherein −12/12 activates the ballast for 12 hours on and deactivates the ballast for 12 hours off; −18/6 activates the ballast for 18 hours on and deactivates the ballast for 6 hours off; −19/5 activates the ballast for 19 hours on and deactivates the ballast for 5 hours off; −20/4 activates the ballast for 20 hours on and deactivates the ballast for 4 hours off; −21/3 activates the ballast for 21 hours on and deactivates the ballast for 3 hours off; −22/2 activates the ballast for 22 hours on and deactivates the ballast for 2 hours off; and −23/1 activates the ballast for 23 hours on and deactivates the ballast for 1 hour off.

It is an object of the present invention to provide a ballast with a counter that functions similar to an odometer. The counter preferably measures and tracks a cumulative operation time or the amount time since the ballast has been initially used, which is similar to an odometer, and may typically be comprised of flip-flops, shift registers, or any type of logic gates.

It is an object of the present invention to provide a ballast with a display screen, which provides a visual output of status information, ballast settings, and hardware error codes.

It is an object of the present invention to provide an ignition control, which allows a user to sequentially ignite lamps one at a time for energy saving and efficiency.

It is an object of the present invention to provide a ballast that conducts a “pre-ignition” check to validate the integrity of the system's connections, and to verify that no issues remain. The “pre-ignition” check tests for: (1) open outputs; (2) ignition failure; (3) lamp end-of-life; (4) over/low voltage; (5) short circuits; (6) thermal issues; (7) overflow current; and (8) high/low temperatures.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of the exterior of one embodiment of the remote controlled ballast

FIG. 2 is an illustration of a front view of the exterior of one embodiment of the remote controlled ballast showing the digital display.

FIG. 3 is an illustration of a rear view of the exterior of one embodiment of the remote controlled ballast.

FIG. 4 is an illustration of one embodiment of a remote control of one embodiment of the remote controlled ballast.

FIG. 5 is an illustration of one embodiment of a display screen of the ballast of the remote controlled ballast.

FIG. 6 is a flow diagram of one embodiment of the remote controlled ballast of the present invention.

FIG. 7 is a flow diagram of one embodiment of the remote control of the remote controlled ballast.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

The remote controlled ballast device proposed by the present invention wirelessly limits and controls the amount of current in an electric circuit that is provided to a lamp or other light source via remote control. The remote controlled ballast preferably includes: a ballast, remote control, and one or more lamps; wherein the ballast is typically connected to one or more lamps. The ballast preferably includes: a wireless interface, counter, digital display screen, central processing unit, and diagnostic circuits. The wireless interface is typically configured to receive one or more wireless signals sent from the remote control; wherein the remote control allows a user to wirelessly activate and configure the ballast. The counter preferably tracks the total hours that the ballast has been operating and typically displays this count, when requested, on the digital display screen. The central processing unit typically includes one or more scheduling functions, which triggers the ballast to ignite and drive one or more lamps at various time intervals. The diagnostic circuits preferably perform a pre-ignition test, and the pre-ignition test should detect fault conditions of the ballast, such as open circuitry, shortages, ignition failures, thermal issues, low-life lamp expectancy, current overflow, over/under voltages, and high/low temperatures. The remote control preferably allows the user to wirelessly: (1) set the wattage output; (2) program start time; (3) program operating time; and (4) turn the lamp on or off. The display preferably provides visual information of the ballast's settings. The ignition control preferably allows the user to start up multiple lamps that are connected to the one or more ballasts sequentially so as to save energy and prevent circuit breakers from tripping.

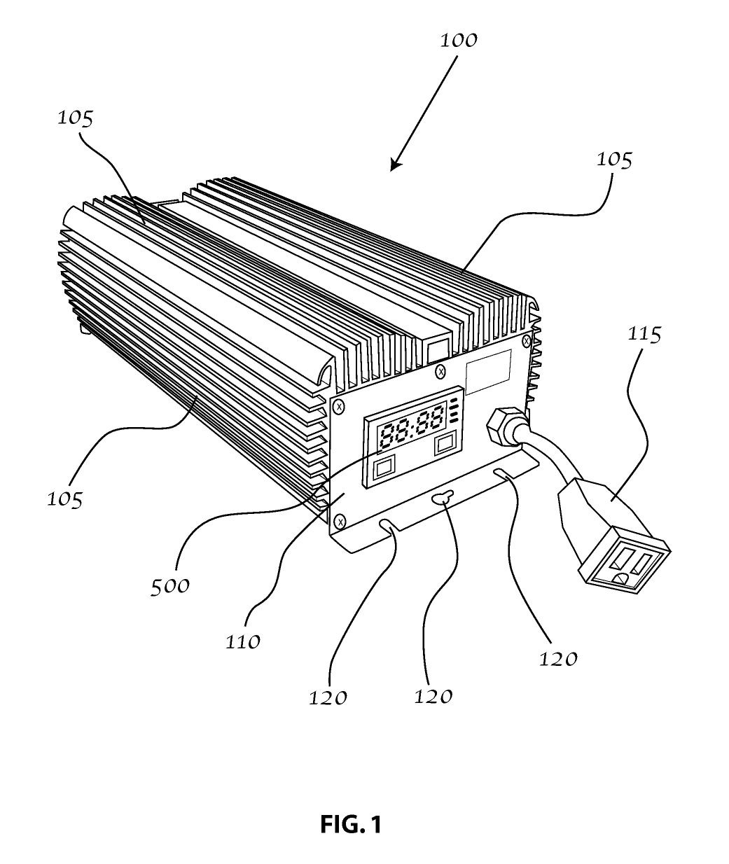

FIG. 1 is an illustration of a perspective view of the exterior of one embodiment of the remote controlled ballast. As shown in FIG. 1, the ballast 100 preferably includes: a housing 105; front plate 110; and female electrical adapter 115. The front plate 110 preferably includes a display screen 500; and screw holes/slots 120. The ballast 100 may also include other parts/components as well without deviating from the scope of the invention. The housing 105 is preferably an enclosure that covers, protects, and supports the inner components of the ballast 100. Preferably, the housing 105 is designed to include a plurality of heat sink fins or edges to transfer heat and provide cooling to the ballast 100. The ballast housing 105 may be constructed as a single piece or multiple pieces without deviating from the scope of the invention. The front plate 110 preferably provides additional protection to the inner components of the ballast 100. The female electrical adapter 115 typically includes a socket, which is adapted to plug any light source such as a fluorescent light bulb or high intensity discharge bulb. The screw holes/slots 120 are preferably configured to be used to mount and secure the ballast 100 on any surface using a fastener, such as a screw or nail. The display screen 500 is preferably a display device that provides various information to the viewer such as wattage settings, error codes, and cumulative operation time of the ballast, but may also display other settings or control information without deviating from the scope of the invention. The display screen 500 may also be any type of display device, such as: electroluminescent; plasma; liquid crystal; high-performance addressing; thin-film transistor; organic light-emitting diode; carbon nanotubes; quantum dot; touch-screen; light emitting diode; and/or cathode ray tube. Further, the display screen 500 and ballast 100 preferably include sensor devices configured to receive wireless signals, such as infrared signals, but may include other signals as well such as radio frequency, microwave signals, cellular signals, blue tooth, and/or wi-fi signals.

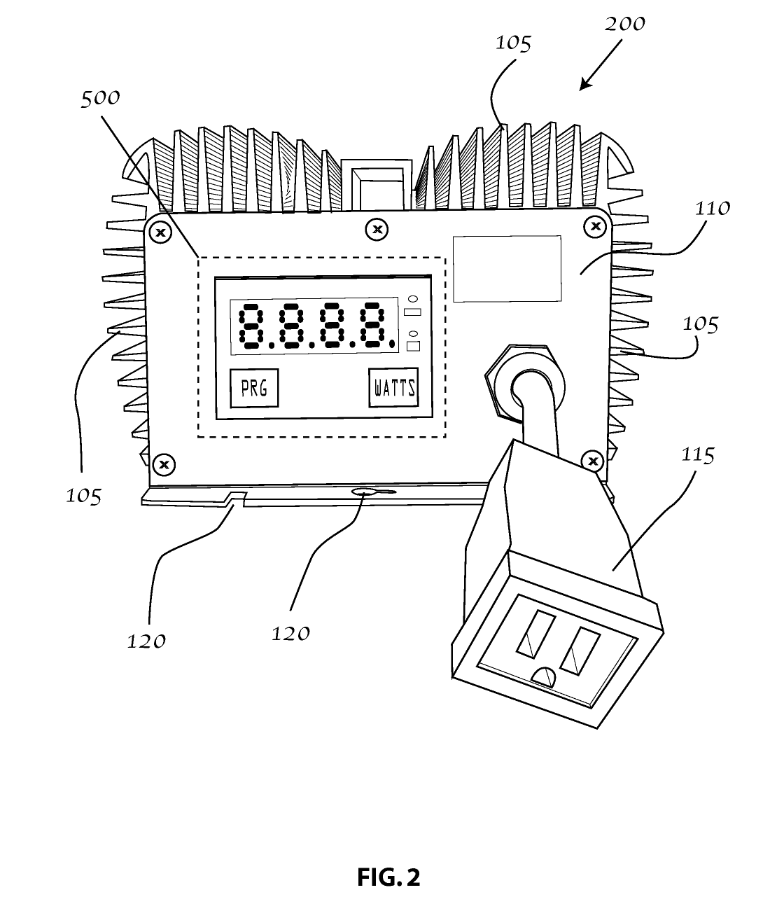

FIG. 2 is an illustration of a front view of the exterior of one embodiment of the remote controlled ballast showing the digital display. As shown in FIG. 2, the ballast 100 preferably includes: a housing 105; front plate 110; and female electrical adapter 115. The front plate 110 preferably includes a display screen 500; and screw holes/slots 120.

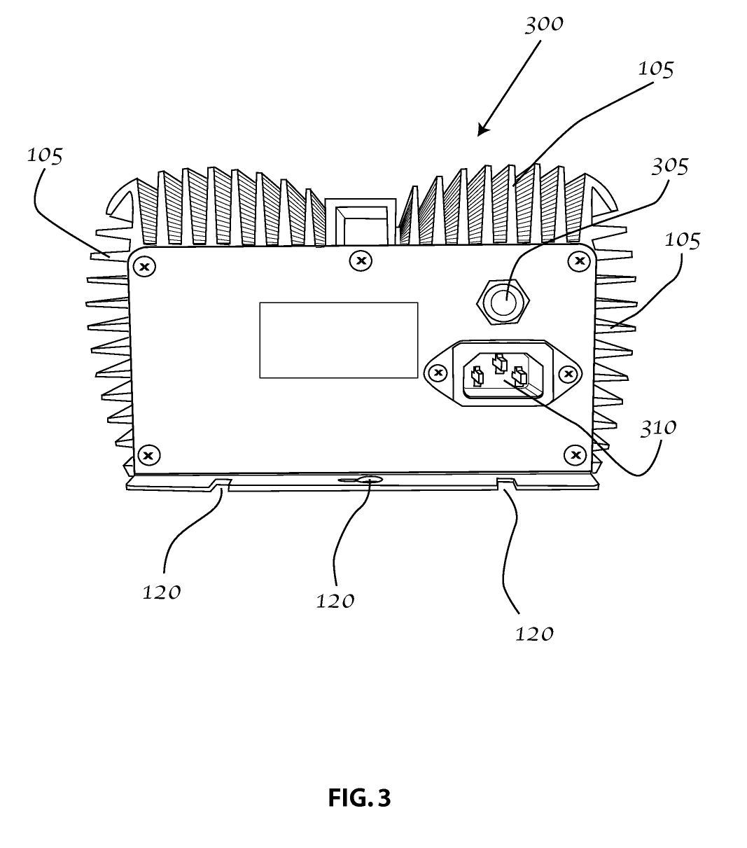

FIG. 3 is an illustration of a rear view of the exterior of one embodiment of the remote controlled ballast. As shown in FIG. 3, the ballast 100 preferably includes: a housing 105; power button or reset switch 305; and power adapter connector 310. The power button or reset switch 205 is preferably a switch that resets or activates the ballast 100 with electrical power. The electrical power flows through the power adapter connector 310, which is preferably a three-prong connection device used to connect a standard power cable to receive an alternating current flow, which typically originates from a 120/240 volt single phase power source.

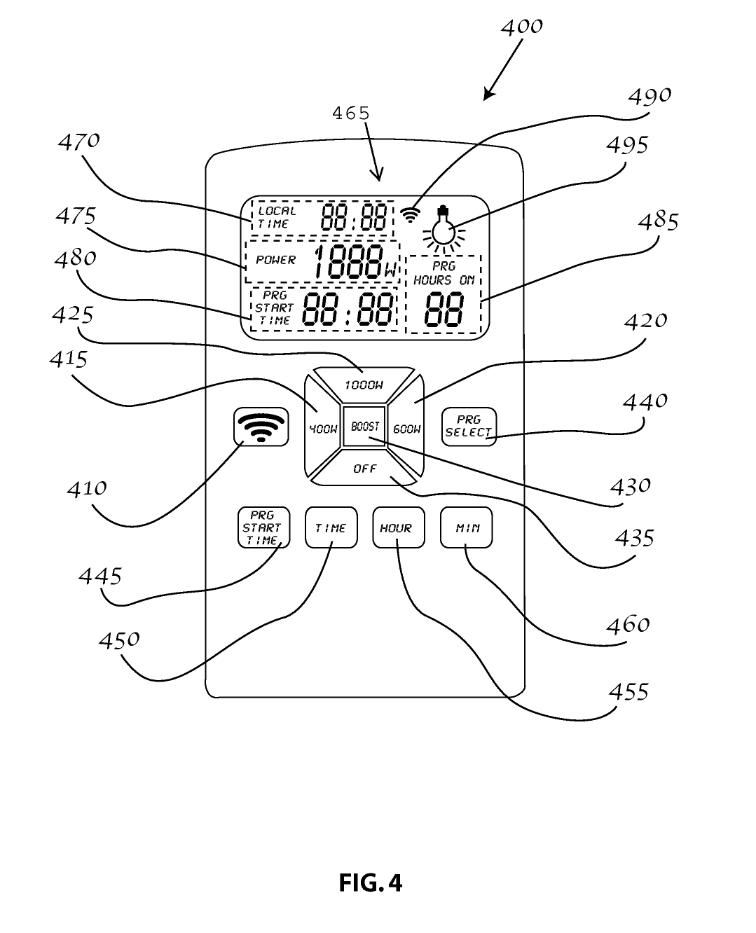

FIG. 4 is an illustration of one embodiment of a remote control of one embodiment of the remote controlled ballast. As shown in FIG. 4, the remote control 400 preferably includes: a sync button 410; 400W button 415; 600W button 420; 1000W button 425; boost button 430; off button 435; program select button 440; program start time button 445; time button 450; hour button 455; minute button 460; and a remote control display screen 465. The sync button 410 preferably synchronizes the remote control 400 with the ballast 100 and allows the ballast 100 to recognize the remote control 400. The 400W button 415, 600W button 420, and 1000W button 425 preferably allows the user to wireless adjust the wattage settings of the ballast 100, such that the 400W button 415 provides a 400 watts setting; the 600W button 420 provides a 600 watts setting; and the 1000W button 425 provides a 1000 watts setting. Although FIG. 4 shows only a 400, 600, and 1000 wattage setting, it should be understood that the present invention allows other wattage settings as well without deviating from the scope of the invention. The boost button 430 preferably provides a overdrive feature such as 5% to the ballast to increase the light output, but the present invention allows the overdrive feature to be set with lower/higher outputs as well such as 2%, 7% and 10%. The off button 435 is preferably used to allow the user to turn off the lamp and enter the ballast 100 into idle mode, and may deactivate the ballast 100 or multiple ballasts as well. The program select button 440 preferably allows the user to pre-set the lighting schedule and grow/bloom programs, and is typically performed after the user adjusts the wattage settings and when the ballast is in idle mode (i.e., after activating the off button 435). After the user presses the program select button 440, the ballast preferably enters into the program and timer mode, which allows the user to select which schedule function to use. Specifically, the remote control 400 should display information of various scheduling functions such as −12/12; −18/6; −19/5; −20/4; −21/3; −22/2; and −23/1; wherein −12/12 activates the ballast for 12 hours and deactivates the ballast for 12 hours; −18/6 activates the ballast for 18 hours and deactivates the ballast for 6 hours; −19/5 activates the ballast for 19 hours and deactivates the ballast for 5 hours; −20/4activates the ballast for 20 hours and deactivates the ballast for 4 hours; −21/3 activates the ballast for 21 hours and deactivates the ballast for 3 hours; −22/2 activates the ballast for 22 hours and deactivates the ballast for 2 hours; and −23/1 activates the ballast for 23 hours and deactivates the ballast for 1 hour. It should be understood, however, that the present invention allows an unlimited amount of different timing and scheduling functions or formats without deviating from the scope of the invention. Preferably, the program start time button 445 permits the user to activate the ballast 100 at a certain time schedule.

The time button 450 may allow the user to adjust the time settings, which include the local time 470; program start time 480; and programmed hours 485; wherein the hour button 455 permits the user to preferably adjust the hour settings and the minute button 460 permits the user to preferably adjust the minute settings. The remote control display screen 465 should provides information regarding the ballast 100 and other pertinent information such as: local time 470; wattage setting 475; program start time 480; program operating time 485; sync information 490; and power icon 495. The local time 470 is typically the current local time in the area, but may display other time information of outside areas as well. The wattage setting 475, as mentioned above, is typically the information that informs the user the configured wattage settings, which include the current and scheduled power settings of the ballast 100. The program start time 480 is preferably the set time in which the ballast 100 will activate and perform its desired timing schedule or scheduling function. The program operating time 485 is preferably information that shows the amount of hours, in which the ballast 100 will be operating. The sync information 490 should indicate whether the remote control 400 is synchronizing with the ballast 100, and the power icon 495 should indicate whether the lamp is on or off. Although FIG. 4 only shows information regarding the local time 470; wattage setting 475; program start time 480; program operating time 485; sync information 490; and power icon 495, the present invention allows the remote control 400 to display other information as well without deviating from the scope of the invention.

In addition to displaying ballast information, the remote control 400 also preferably configures wirelessly one or more ballast information. The one or more ballast information preferably include wattage settings; program start time; and program operating time. The wattage settings typically display the configured wattage output and scheduled wattage output of the ballast 100. The program start time is typically the desired time schedule, in which the ballast 100 is activated. The program operating time preferably is the amount of time, in which the ballast 100 will be or has been operating.

Preferably, the remote control 400 has a wireless range of at least 5 meters (i.e., 16.5 feet) with a wide angle peripheral sensor preferably up to 45 degrees to both left and front right of the ballast, but may allow different angles and ranges. Preferably, the remote control 400 utilizes an infrared direct line of sight to communicate with the ballast 100, to prevent anyone in the area from altering the program settings of the scheduling functions. However, it should be understood that the present invention allows any type of wireless communication such as radio frequency technology, microwave communication, cellular communications, wi-fi, blue tooth, and satellite communication without deviating from the scope of the invention.

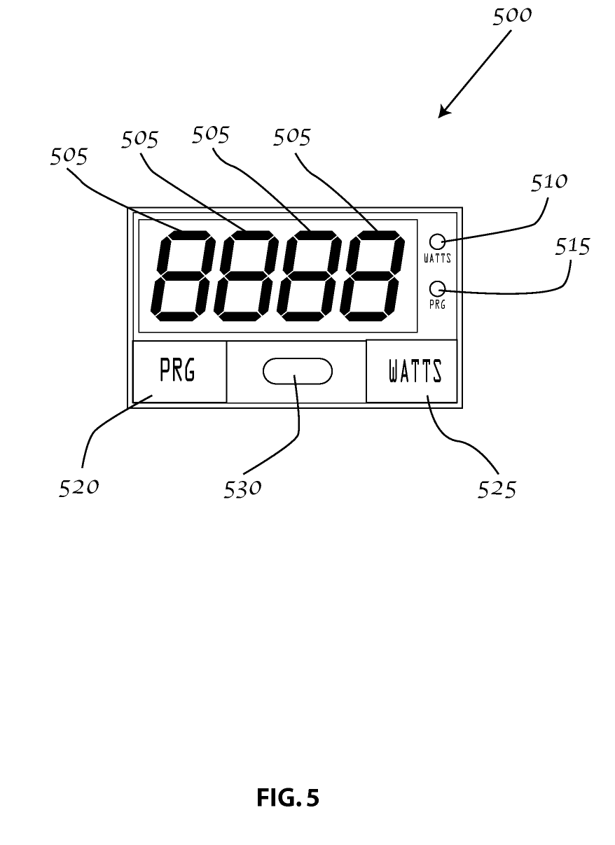

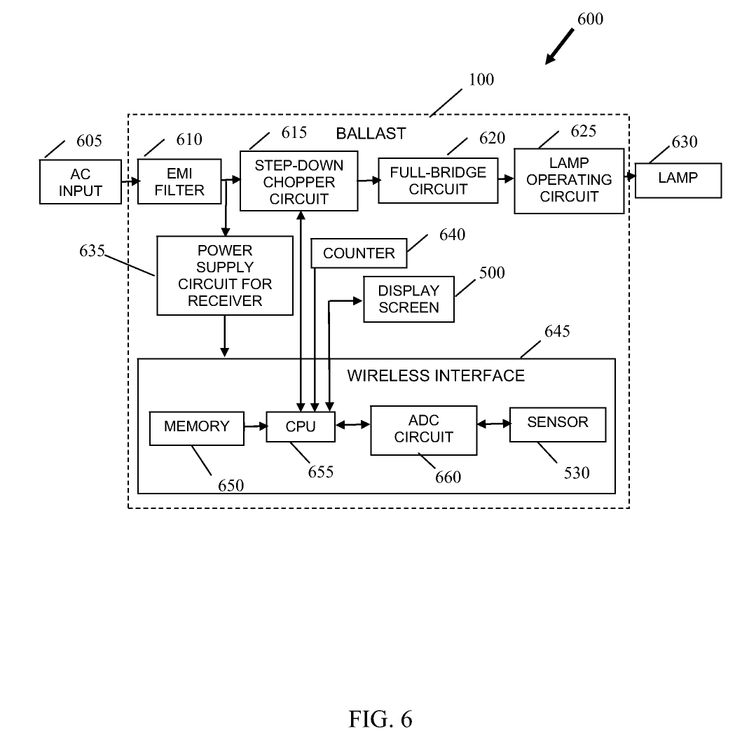

FIG. 5 is an illustration of one embodiment of a display screen of the ballast of the remote controlled ballast. As shown in FIG. 5, the display screen 500 preferably includes: alphanumeric displays 505; wattage light indicator 510; program light indicator 515; PRG button 520; WATTS button 525; and sensor 530. The alphanumeric displays 505 preferably provide alphanumeric information, regarding wattage output settings, program settings, fault conditions to indicate various faults, and like. The fault conditions provide error codes that would be displayed in the display screen 500 and typically include faults such as over voltage, under voltage, over heat, open circuit, and short circuit, but may typically include other fault conditions as well. Preferably such fault conditions are a result of pre-ignition testing; wherein the ballast 100 performs a check on the system before activating the one or more lamps. The wattage light indicator 510 typically indicates when wattage settings are displayed. The program light indicator 515 typically provides an indication when a program is being set and whether a program is currently active. The PRG button 520 preferably allows a user to enter and manually set a certain program. The WATTS button 525 preferably allows a user to cycle through a desired wattage setting and may function as a select button to select and save a desired program. The ballast 100 may also display a cumulative operation time, in which the ballast has been operating since its initial use, and may be displayed when a user presses both the PRG button 520 and WATTS button 525 simultaneously. Although FIG. 5 only shows two buttons, two light indicators, and four alphanumeric screens, it should be understood that the present invention may include additional/fewer buttons, light indicators, and alphanumeric characters as well, without deviating from the scope of the invention. The sensor 530 is preferably part of the ballast' wireless interface 645 (shown in FIG. 6) and preferably receives an infrared wireless signal but may accept other wireless signals as well such as a wi-fi signal, microwave signal, or radio frequency signal. The sensor 530 also may be the wireless interface itself without deviating from the scope of the invention.

FIG. 6 is a flow diagram of one embodiment of the remote controlled ballast of the present invention. As shown in FIG. 6, the block diagram 600 of the ballast 100 preferably includes: an alternating current input (“AC input”) 605; electromagnetic interference filter (“EMI filter”) 610; step-down chopper circuit 615; full bridge circuit 620; lamp operating circuit 625; lamp 630; power supply circuit 635; counter 640; wireless interface 645; and display screen 500. The AC input 605 typically is the alternating current originating from any alternating current (“AC”) power supply, and typically originates from a wall outlet. While FIG. 6 only shows an AC input for a power supply, the present invention allows the ballast to receive other sources of electric power such as power supply fixtures, AC/DC power supplies, DC power supplies, switched-mode power supplies, high-voltage power supplies and the like without deviating from the scope of the invention. The EMI filter 610 preferably is any circuit or device that filters out any noise or electromagnetic interference that may affect the ballast's internal circuitry. The EMI filter 610 also may consist of one or more capacitors and/or inductors and may be configured to be one or more low-pass, high-pass, or bandpass filter circuits. The step-down chopper circuit 615 is preferably any circuit or device that would receive the filtered alternating current, convert the electric current from alternating current to direct current (i.e., DC current), and reduce the DC current to a lower voltage level. Preferably, the step-down chopper circuit 615 includes a rectifier, boost power factor correction (“boost PFC”) circuit, and a buck circuit. The rectifier preferably converts the alternating current to direct current, and the boost PFC is preferably a correction circuit that adjusts the ratio of the real power to the apparent power to efficiently provide electric current to the buck circuit. Preferably, the buck circuit is any circuit or device that controls and limits the ballast's lamp current and power, and is typically a DC-to-DC voltage converter. The full bridge circuit 620 is preferably the circuitry that receives an electric current from the step-down chopper circuit 615 and produces a larger output power, which is sent to the lamp's operating circuit 625, and typically consists of diodes or a pulse transformer circuit. Additionally, the full bridge circuit 620 typically operates at 200 Hz with a 50% duty-cycle, but may operate in any type of frequency and duty-cycle without deviating from the scope of the invention. The lamp operating circuit 625 preferably is any circuitry that receives the electric current from the full-bridge circuit 620 and applies such current to a lamp 630. The lamp operating circuit 625 preferably includes: an ignition circuit to ignite the lamp 630; and diagnostic circuits; wherein the diagnostic circuits perform pre-ignition tests to verify the ballast's and lamp's integrity. The diagnostic circuits typically consists of: an additional voltage/current sensing circuit to safely enable or disable the ignition circuit; and a programmable fault timer to assist in checking for various fault conditions in the circuitry. Examples of such fault conditions include, without limitation, failure of the lamp to ignite, failure of the lamp to warm-up; end-of-lamp life faults; temperature failure faults; open circuits; short circuits; ignition failure faults; and arc instabilities. Preferably, within the lamp operating circuitry, an ignition control is performed using an ignition timing output that drives a switch on/off to enable the ignition circuitry, and may be programmed externally to set the ignition circuit on and off times. However, the present invention allows the inclusion of other types of fault detection circuitry without deviating from the scope of the invention. The counter 640 preferably is a circuit that measures and tracks a cumulative operation time or the amount time since the ballast has been initially used, which is similar to an odometer, and may typically be comprised of flip-flops, shift registers, or any type of logic gates. The power supply circuit 635 preferably receives the filtered AC current and provides power to the ballast 100 and wireless interface 645. The display screen 500, as mentioned above, preferably displays information such as error codes and ballast settings information, and typically receives digital signals sent from the central processing unit (“CPU ”) 655.

FIG. 6 also shows the inner workings of the wireless interface 645. The wireless interface 645 preferably includes: a sensor 530; analog-to-digital converter circuit (“ADC circuit”) 660; CPU 655; and memory 650. The sensor 530 preferably receives one or more wireless signals from the remote control 400, which is typically an analog infrared signal, but may be other types of wireless signals as well such as wi-fi, cellular technology, and the like. Additionally, the present invention may utilize an antenna rather than a sensor 530. The ADC circuit 660 preferably receives the wireless signal received from the sensor 530 and converts the wireless signal into a digital electric signals for processing. The CPU 655 is preferably a microcontroller and preferably receives the DC electric signal to process the signal into one or more signals for further processing in the ballast 600. Additionally, the CPU 655, typically in combination with the memory 650, should include data information regarding the scheduling functions of the ballast for a desired grow/bloom light schedule. The one or more signals from the CPU are typically sent into the step-down chopper circuit 615 to adjust certain ballast settings such as the wattage output and scheduling timer, and also sent to the display screen 500 to display ballast information. The wireless interface 645 typically includes memory 650 to store hardware settings of the CPU 655, but may utilize dual inline package chips. While FIG. 6 shows block diagrams of several circuits, the present invention allows any a single circuit or multiple circuits to be incorporated into a single device without deviating from the scope of the invention.

A general summary of one embodiment of the ballast's electric flow is as follows: As the filtered AC current enters the step-down chopper circuit 615, the rectifier converts the AC current to DC current. The DC current is then corrected through the boost PFC to compensate any energy lost in a power distribution system—especially because loads with a low power factor draws more current than a load with a high power factor. After the DC power factor is corrected, the buck circuit converts the DC voltage level to adjust into the full bridge circuitry. The electric signals leaving the full-bridge circuit enter into the lamp operating circuit preferably to ignite the lamp. The lamp operating circuit also includes diagnostic circuits that typically detect fault conditions of the ballast. Additionally, as wireless signals such as an IR signal enter the sensor portion of the wireless interface 645, the wireless signal is converted into a DC signal through the ADC circuit; wherein the DC signal enters the CPU for processing, preferably in accordance with the scheduling function settings of one or more memory proms. The power supply preferably provides power to the ballast 100.

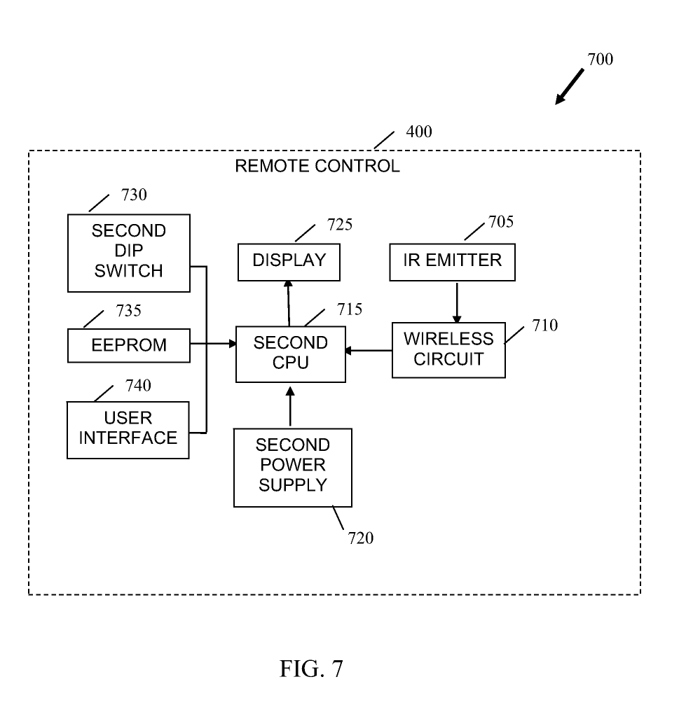

FIG. 7 is a flow diagram of one embodiment of the remote control of the remote controlled ballast. As shown in FIG. 7, the block diagram 700 of the remote control 400 preferably includes: an emitter 705; wireless circuit 710; second CPU 715; second power supply 720; remote control display screen 725; DIP switch 730; electrically erasable programmable read-only memory (“EEPROM”) 735; and user interface 740. In this embodiment, the DIP switch 730 may store predetermined information, which can be manually configured by the user. The second power supply 720 in the remote control 400 typically supplies power to the second CPU 715 and other electronic components of the remote control 400. The second power supply 720 also preferably uses a battery, but may use different types of power sources such as a power fixture or wall outlet. The user interface 740 is typically one or more buttons of the remote control 400, which are used to input information to specify a specified ballast setting, control, or command, and preferably includes the following buttons: a sync button 410; 400W button 415; 600W button 420; 1000W button 425; boost button 430; off button 435; program select button 440; program start time button 445; time button 450; hour button 455; a minute button 460; and the like. The emitter 705 typically emits an IR signal, which may vary in frequency but may be approximately 40 KHz in pulse-width method or bi-phase method; wherein the IR signal includes commands signals selected by the user and is preferably sent to the sensor 530 of the ballast 100 for further processing. The second CPU 715 preferably processes the signals received from the user interface 740 and typically reads the predetermined information from the DIP switch 730. The second CPU 715 also preferably sends processed information into their wireless circuit 710, which thereby sends wireless signals through the emitter 705, and/or also to the remote control display screen 725 for viewing the ballast settings or configurations. The EEPROM 735 preferably includes predetermined information of the ballast or command information sent from the user interface 740, and typically stores such commands, such that when new information is input by the user, the old information is overwritten by new information. Additionally, when the remote control 400 cycles power, the second CPU 715 can read the new information stored in the EEPROM 735 and can send a new command even without input from the user interface 740.

When the user inputs new information on the remote control 400, the second CPU 715 instructs the wireless circuit 710 to preferably send a wireless signal, which is generally an IR signal. The ballast 100 usually receives the wireless signal through its sensor 530. The second CPU typically sends the command information stored in the EEPROM 735 and/or the information stored by the DIP switch 730 to the wireless circuit. The wireless circuit 710 should thus send these pieces of information as a control command through the emitter 705.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A remote controlled ballast, comprising:
a ballast; and
a remote control;
wherein said ballast is connected to one or more lamps;
wherein said ballast includes a wireless interface and a counter;
wherein said wireless interface receives one or more signals sent from said remote control;
wherein said remote control allows a user to wirelessly activate said ballast;
wherein said remote control allows said user to wirelessly configure said ballast; and
wherein said counter tracks a cumulative operation time of said ballast.

2. The remote controlled ballast according to claim 1, wherein said ballast includes a central processing unit;
wherein said central processing unit includes one or more scheduling functions; and
wherein said one or more scheduling functions are selected by said user;
wherein said one or more scheduling functions triggers said ballast to ignite and drive said one or more lamps at one or more time intervals.

3. The remote controlled ballast according to claim 2, wherein said ballast includes one or more diagnostic circuits;
wherein said one or more diagnostic circuits performs a pre-ignition test;
wherein said pre-ignition test detects one or more fault conditions of said ballast and of said one or more lamps.

4. The remote controlled ballast according to claim 3, wherein said one or more fault conditions is an end-of-lamp life fault.

5. The remote controlled ballast according to claim 4, wherein said one or more fault conditions is a temperature failure fault.

6. The remote controlled ballast according to claim 5, wherein said one or more fault conditions are selected from the group consisting of: an open circuit; a short circuit; and an ignition failure fault

7. The remote controlled ballast according to claim 6, wherein said ballast includes one or more display screens.

8. The remote controlled ballast according to claim 7, wherein said one or more display screens displays said cumulative operation time.

9. The remote controlled ballast according to claim 8, wherein said remote control includes:
one or more remote control display screens;
wherein said one or more remote control screens display one or more ballast information;
wherein said one or more ballast information is selected from the group consisting of: a wattage setting; a program start time; and a program operating time;
wherein said wattage setting is a desired wattage configuration of said ballast;
wherein said program start time is an initial start time of said one or more scheduling functions; and
wherein said program operating time is a total scheduled operation time of said one or more scheduling functions, in which said ballast is scheduled to operate.

10. The remote controlled ballast according to claim 9, wherein said remote control includes an ignition control;
wherein said ignition control allows said user to ignite at least two lamps sequentially when said at least two lamps are connected to at least two ballasts.

11. A remote controlled ballast, comprising:
a ballast; and
a remote control;
wherein said ballast is connected to one or more lamps;
wherein said ballast includes a wireless interface and one or more display screens;
wherein said wireless interface receives one or more signals sent from said remote control;
wherein said remote control allows a user to wirelessly activate and configure said ballast; and
wherein said remote control allows said user to wirelessly configure said ballast.

12. The remote controlled ballast according to claim 11, wherein said ballast includes a counter;
wherein said counter tracks a cumulative operation time of said ballast.

13. The remote controlled ballast according to claim 12, wherein said one or more display screens displays said cumulative operation time.

14. The remote controlled ballast according to claim 13, wherein said ballast includes a central processing unit;
wherein said central processing unit includes one or more scheduling functions; and
wherein said one or more scheduling functions are selected by said user;
wherein said one or more scheduling functions triggers said ballast to ignite and drive said one or more lamps at one or more time intervals.

15. The remote controlled ballast according to claim 14, wherein said ballast includes one or more diagnostic circuits;
wherein said one or more diagnostic circuits performs a pre-ignition test;
wherein said pre-ignition test detects one or more fault conditions of said ballast and of said one or more lamps.

16. The remote controlled ballast according to claim 15, wherein said remote control includes one or more remote control screens;
wherein said one or more remote control screens display one or more ballast information;
wherein said one or more ballast information is selected from the group consisting of: a wattage setting; a program start time; and a program operating time;
wherein said wattage setting is a desired wattage configuration of said ballast;
wherein said program start time is an initial start time of said one or more scheduling functions; and
wherein said program operating time is a total scheduled operation time of said one or more scheduling functions, in which said ballast is scheduled to operate.

17. The remote controlled ballast according to claim 16, wherein said remote control includes an ignition control;
wherein said ignition control allows said user to ignite at least two lamps sequentially when said at least two lamps are connected to at least two ballasts.

18. The remote controlled ballast according to claim 17, wherein said one or more fault conditions is selected from the group consisting of: an open circuit fault;
a short circuit fault; an ignition failure fault; a temperature failure; and an end-of-lamp life.

19. A remote controlled ballast, comprising:
a ballast; and
a remote control;
wherein said ballast is connected to one or more lamps;
wherein said ballast includes a wireless interface; a counter; a central processing unit; one or more diagnostic circuits; and one or more display screens;
wherein said wireless interface receives one or more signals sent from said remote control;
wherein said remote control allows a user to wirelessly activate said ballast;
wherein said remote control allows said user to wirelessly configure said ballast;
wherein said counter tracks a cumulative operation time of said ballast.
wherein said central processing unit includes one or more scheduling functions;
wherein said one or more scheduling functions are selected by said user;
wherein said one or more scheduling functions triggers said ballast to ignite and drive said one or more lamps at one or more time intervals;
wherein said ballast includes one or more diagnostic circuits;
wherein said one or more diagnostic circuits performs a pre-ignition test;
wherein said pre-ignition test detects one or more fault conditions of said ballast and one or more lamps;
wherein said one or more fault conditions is selected from the group consisting of: an end-of-lamp life fault; a temperature failure fault; an open circuit fault; a short circuit fault; and an ignition failure fault;
wherein said one or more display screens displays said cumulative operation time; and
wherein said one or more display screens displays said one or more fault conditions of said ballast and said one or more lamps.

20. The remote controlled ballast according to claim 19, wherein said remote control includes:
one or more remote control display screens; and
an ignition control;
wherein said one or more remote control screens display one or more ballast information;
wherein said one or more ballast information is selected from the group consisting of: a wattage setting; a program start time; and a program operating time;
wherein said wattage setting is a desired wattage configuration of said ballast;
wherein said program start time is an initial start time of said one or more scheduling functions;
wherein said program operating time is a total scheduled operation time of said one or more scheduling functions, in which said ballast is scheduled to operate; and
wherein said ignition control allows said user to ignite at least two lamps sequentially when said at least two lamps are connected to at least two ballasts.
